(19) United States
(12) Patent Application Publication
(10) Pub. No.: US 2001/0033909 A1
(43) Pub. Date: Oct. 25, 2001

(54) Reinforced toner seal tear strip construction

(76) Inventors: Lester E. Cornelius, Oyster Bay, NY (US); Colin Davison, Hong Kong (CN)

Correspondence Address: Charles E. Temko, 22 Marion Road, Westport, CT, 06880, US

(21) Appl. No.: 09/783,520

(22) Filed: Feb. 15, 2001

Related U.S. Application Data
(60) Provisional application No. 60/187,591, filed on Mar. 7, 2000.
(60) Provisional application No. 60/216,742, filed on Jul. 7, 2000.

(51) Int. Cl. B32B 5/12

(52) U.S. Cl. 428/114

(57) ABSTRACT

A synthetic resinous tear strip seal or toner cartridge used in electrostatic copy machines, in which the longitudinal central area of the strip is reinforced by laminating additional planar material thereto in the area overlying the elongated opening in the toner cartridge, and preferably along at least part of the tear strip. The material may be similar to that of the seal, or of other material selected for electrostatic conductivity to dissipate the electrostatic attraction of the seal material to the toner particles in the toner cartridge hopper. Typically, a thin coating of aluminum is applied to the material which is of a synthetic resin.

### RELATED APPLICATION

Reference is made to the corresponding provisional application of Applicant, Lester Cornelius, Ser. No. 60/187/591 filed Mar. 7, 2000, and to our joint copending provisional application Ser. No. 60/216,742 filed Jul. 7, 2000 from which a claim of priority is made.

This invention relates generally to the field of tearable synthetic resinous seals used in toner cartridges for electrostatic copying machines, and more particularly to an improved construction having means for assuring that with the tearing operation after installation of the cartridge, the opening formed in the seal will be of uniform width corresponding to the opening in the toner cartridge hopper.

It is desirable to contain toner in a toner cartridge until the cartridge is to be used. Failing to contain the toner may result in toner leakage of the cartridge especially during shipping. Various seals and sealing materials have been used to contain the toner, including pressure-sensitive adhesive-backed seals, hot melt backed seals, and foam gasketed seals held in place under compression after installation.

A toner seal should not only prevent toner from leaking. It should be easy to remove and its removal should result in an opening that is of constant width throughout the axial length thereof. The complex geometry of toner cartridges typically requires a central strip of seal material to be removed by tearing, thus exposing the toner hopper opening and allowing toner to pass therethrough.

One of the common seal materials used is parallel-extruded polypropylene or polyethylene fibers that are bound together along their length by fusing the material as it is extruded. These are referred to as ribbon seals, because the material is commonly manufactured as ribbon.

Ribbon materials are not specifically designed to tear in a particular fashion, although they tend to tear along their axial length, or in one direction, removing a section of material by beginning a tear at two spaced terminal points. This does not necessarily result in a consistent width of the material removed.

In order to create a parallel longitudinal edge seal tear strip, various techniques have been used including small cuts at the tear edge of the seal material, perforations, and reinforced areas at the transverse edge of the seal.

Another problem common to relatively thin seals which are adhered to the peripheral area surrounding the mouth of the toner opening in the cartridge is the tendency to pull free from adhesion at the ends thereof where the tear strip is pulled to form the opening in the seal resulting in a seal which is progressively crumpled rather than opened, necessitating removal and replacement, a rather messy procedure. This problem is usually caused by the failure to properly start the tearing action referred to above.

### SUMMARY OF THE INVENTION

Briefly stated, the invention contemplates the provision of an improved synthetic resinous seal construction in which the longitudinal edges of the tear strip portion along which the tearing operation procedure is performed is strengthened by the lamination of additional longitudinally-extending material which may include electrically conductive properties, so as to dissipate the electrostatic charge normally present in the particulate toner in the hopper portion of the cartridge. This action will result in a removable tear strip portion which will be relatively free of toner particles on the surface of the strip after it is removed, thus avoiding soiling of the hands or garments of the user during installation of the toner cartridge. To this end, a second layer of seal ribbon material is laminated along the full length of the primary seal material at the centrally disposed tear portion which creates increased burst resistance, and a full length guide for the pull strip tab. This full length lamination can be placed on the side away from the toner, or on the side facing the toner. With most ribbon materials, it is preferable to place the lamination on the side facing the toner. It is also preferable to place the lamination strip so that one transverse edge is located either at the edge of the main seal material, or such that it extends past the edge into the manually-engageable pull strip area that is external to the main seal material. The best results have been obtained when the lamination layer is placed on the bottom surface of the principal seal material (facing the toner), and extends beyond the pull strip starting point.

It is of additional value to use a ribbon material that is electrically conductive to dissipate the normally occurring electrostatic attraction of the toner to the seal material. This can be accomplished by coating the material with a thin metallic layer such as aluminum to a thickness between—0.001 and 0.003 inch. Alternatively, the supplemental material may be of a type which does not charge the toner, such as a material that creates an opposite triboelectric charge. A first example would be a polypropylene or polyethylene tape that forms the lamination strip. Both polyethylene and polypropylene may be used effectively with negatively charged toner particles. Nylon material may be used with positively charged toner particles.

The laminating strip may be adhered to the main seal material by various means, any of which must withstand the forces of the tearing process. Such means include, but are not limited to pressure-sensitive adhesive, hot melt glue, and heat fusing for fusible seals.

In the case of seals of relatively thin cross section, to avoid the above-mentioned crumpling of the seal, we have provided reinforcing members of C-shaped configuration which are adhered or fused to the surface of the seal surrounding the area at which the tearing action commences, the reinforcing member serving to stiffen this area to resist wrinkling should the adhesive on the seal not fully adhere to the mouth of the cartridge. These members may be of heavy gauge synthetic resinous material, and they also may be positioned at the end distal from the area of commencement of the tearing action to be interconnected only along the axially oriented portions thereof and provide a non-fused transverse area which serves to guide the tear strip as it is pulled.

### BRIEF DESCRIPTION OF THE DRAWINGS

In the drawings, to which reference will be made in the specification, similar reference characters have been employed to designate corresponding parts throughout the several views.

FIG. 1 is a fragmentary top plan view of the embodiment of the invention.

FIG. 2 is a fragmentary transverse sectional view thereof.

FIG. 3 is a side elevational view thereof showing the tearing operation of the embodiment after installation of the seal.

FIG. 4 is a top plan view showing an alternate form of the embodiment.

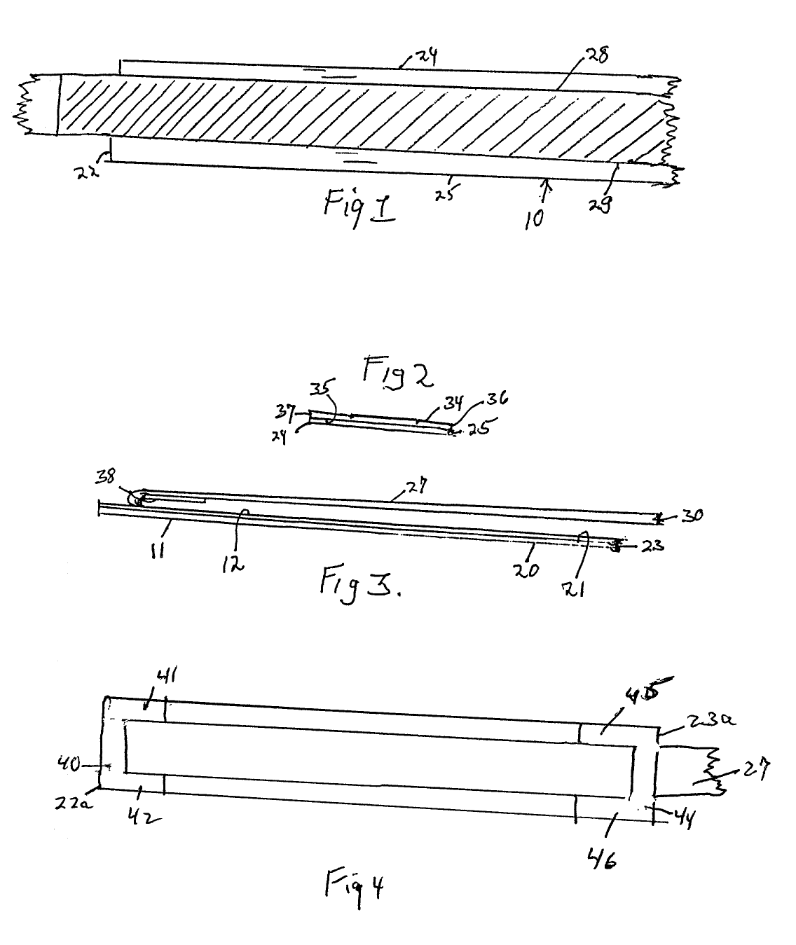

### DETAILED DESCRIPTION OF THE DISCLOSED EMBODIMENT

In accordance with the invention, the device, generally indicated by reference character 10, comprises broadly a first or principal lamina 11 and a second generally congruent lamina 12.

The first lamina 11 is of construction generally known in the art, and is formed from ribbon material comprising longitudinally-aligned fibers, typically polyethylene or polypropylene, which are fused together in a principal axial direction during extrusion. It includes a first exposed surface 20, a second laminated surface 21, a first end edge 22, a second end edge 23, as well as longitudinal edges 24 and 25. Extending from the first end edge 22 is a tear strip leader 27 bounded by first and second longitudinal edges 28 and 29 which is normally folded through 180 degrees and projects outwardly of the second end edge 23 so as to be manually engageable after the seal is installed. It thus, forms an end 30 which projects outwardly of the cartridge (not shown). The second lamina, as mentioned hereinabove, is of congruent configuration, and is laminated to the surface 21 only in the centrally-disposed longitudinally-extending area which forms the tear strip. It is bounded by an exposed surface 34, a laminated surface 35, and first and second longitudinal edges 36 and 37. A relatively short portion 38 is also laminated to the proximal part of the tear leader portion 31. Referring to FIGS. 2 and 3 in the drawing, it will be apparent that after the first lamina 11 is secured to the toner cartridge to surround the elongated opening therein, additional burst strength will be obtained by the fact that the second lamina is laminated to the first lamina in the areas which would be subjected to greatest stress during shipping and handling. Once the seal is installed in a toner cartridge (not shown), and the cartridge itself installed within a copying machine, the tear strip is removed in a normal manner. The tear strip portion itself is at least partially of increased thickness, and the laminated edges of the second lamina effectively define the parallel tear lines along which the tear strip is removed, thus assuring a uniform width of the opening formed in the seal at the conclusion of the tearing operation. This result determines that the full width of the opening in the toner hopper will be exposed. As mentioned above, the second lamina may be selected from a material which is electrically conductive, and is thus capable of dissipating triboelectric charges in the toner particles. With positively charged particles, polypropylene and polyethylene are suitable. In the case of negatively charged toner particles, the second lamina may be manufactured from extruded nylon rather than polyethylene or polypropylene.

Referring to the alternate form of the embodiment shown in FIG. 4, there have been laminated to the first end edge 22A a generally C-shaped reinforcing lamina of material of thickness equivalent to three to five times the thickness of the seal. At an opposite edge 23 there is a second C-shaped member which may be made of foam material and bonded only at the longitudinally-extending portions thereof to provide a guiding slot for the tear strip. When made of foam material, it exerts a slight compressive force upon the tear strip to preserve any part of the tearing action which has already been made.

Turning now to FIG. 4, a first end edge 22C locates a C-shaped reinforcing member 40 including axially oriented portions 41 and 42 and a transversely extending member 43, all of which are adhered to the end of the seal outwardly of the area of commencement of tearing, wherein the above-mentioned crumpling as the seal is unintentionally torn from its engagement surrounding the mouth of the toner occurs. A similar C-shaped member 44 is positioned at the opposite edge 23A including axially oriented portions 45 and 46 which are adhered to the seal, and a transversely extending portion 47 which is not adhered to provide a guide for the tear strip prior to and during the time it is pulled.

It may thus be seen that we have invented novel and highly useful improvements in toner cartridge seal tear strip construction, in which we have provided means for assuring that the elongated opening in the toner hopper will be of uniform width. We have also provided a tear strip construction which will repel the normal attraction of toner charged particles, so that upon removal of the tear strip, the hands and garments of the user will remain relatively clean.

We wish it to be understood that we do not consider the invention to be limited to the precise details of structure shown and set forth in the specification, for obvious modifications will occur to those skilled in the art to which the invention pertains.

We claim:

1. A synthetic resinous toner seal of tear strip type for electrostatic copiers comprising: a base lamina of material having a principal axis, and formed by extruding parallel elongated fibers which are axially oriented in fused relation, wherein a central axially oriented portion of the lamina may be torn along said axis to form an elongated opening for the passage of toner; and a second reinforcing lamina of substantially congruent configuration at least partially laminated to a surface of said base lamina over mutually contacting surfaces, said second lamina being formed from axially oriented fibers, which when laminated are parallel to the fibers of said first lamina, whereby said first and second laminae may be torn as an integral centrally located tear strip.

2. A seal in accordance with claim 1, in which said first and second laminae are laminated only in the area forming said tear strip.

3. A seal in accordance with claim 1, in which said first and second laminae are formed from similar materials.

4. A seal in accordance with claim 1, in which at least said second lamina is formed of electroconductive material.

5. A seal in accordance with claim 4, in which said second lamina is formed from material capable of dissipating a triboelectric charge from contacting toner particles.

6. A seal in accordance with claim 5, in which said second lamina is formed of polyethylene.

7. A seal in accordance with claim 5, in which said second lamina is formed from polypropylene.

8. A seal in accordance with claim 5, in which said second lamina is formed from nylon.

9. A seal in accordance with claim 1, further comprising an additional layer of material at least partially surrounding an area of initial tearing and adhered to a planar surface thereof to prevent wrinkling of said area during a tearing operation.

10. A seal in accordance with claim 9, further comprising a second layer of material adhered to said surface of said seal at an area distal to said area of initial tearing, and forming a guide for said tear strip.

11. The method of making a seal for toner cartridges comprising the steps of:
a) providing a strip of material having a principal axis formed of fused elongated fibers, and having a given width;
b) providing a second strip of material formed of fused elongated fibers having a second principal axis, and of width corresponding to that of said first strip;
c) placing said first and second strips in congruent relation, and;
d) laminating said first and second strips over an axially oriented centrally disposed area to form an integral tear strip portion.

12. A seal for enclosing a slotted opening in a toner cartridge forming part of an electrostatic copying machine, said seal including an elongated strip of molecularly-oriented synthetic resinous material forming a first lamina, said strip having an axially-extending manually engageable tear strip extending from a centrally disposed area of an end of said first lamina therefrom to form an elongated opening overlying said opening in said toner cartridge, and a pressure sensitive adhesive layer forming a second lamina having first and second surfaces, a first surface being adhered to a surface of said first lamina, and a second surface selectively adhered to a surface of said toner cartridge bordering said slotted opening, the improvement comprising: said surface of said first lamina having a coating of a material capable of dissipating normally occurring electrostatic charges present in said first lamina.

13. The improvement set forth in claim 12 in which the coating is aluminum.

14. The improvement set forth in claim 13 in which the coating is vacuum deposited upon said surface of said first lamina to a thickness varying from 0.001 to 0.003 inch.
